(19) United States
(12) Patent Application Publication
(10) Pub. No.: US 2012/0134670 A1
(43) Pub. Date: May 31, 2012

(54) TRANSMITTING DEVICE AND TRANSMITTING/RECEIVING DEVICE

(75) Inventor: Tsutomu HAMADA, Kanagawa (JP)

(73) Assignee: FUJI XEROX CO., LTD., Tokyo (JP)

(21) Appl. No.: 13/111,277

(22) Filed: May 19, 2011

(30) Foreign Application Priority Data
Nov. 30, 2010 (JP) 2010-266386

(51) Int. Cl. H04J 14/00

(52) U.S. Cl. 398/43

(57) ABSTRACT

A transmitting device includes a first optical transmitting medium, a second optical transmitting medium, and an optical multiplexing portion. The first optical transmitting medium outputs a first optical signal having a predetermined signal cycle. The second optical transmitting medium outputs a second optical signal obtained by delaying the first optical signal by one cycle of the predetermined signal cycle. The optical multiplexing portion is connected to an output side of the first optical transmitting medium and the second optical transmitting medium and generates a third optical signal obtained by multiplexing the first optical signal and the second optical signal.

### CROSS-REFERENCE TO RELATED APPLICATIONS

This application is based upon and claims priority under 35 USC 119 from Japanese Patent Application No. 2010-266386, filed Nov. 30, 2010.

### BACKGROUND

1. Technical Field

The present invention relates to a transmitting device and a transmitting/receiving device.

2. Related Art

In an optical transmitting/receiving device for transmitting 1-bit information in a single signal cycle, conventionally, there is known a use of a duo-binary transmitting method for transmitting information without an error while permitting an interference with front and rear bit signals in a transmitting path of an optical fiber.

### SUMMARY OF THE INVENTION

According to an aspect of the invention, a transmitting device includes a first optical transmitting medium, a second optical transmitting medium, and an optical multiplexing portion. The first optical transmitting medium outputs a first optical signal having a predetermined signal cycle. The second optical transmitting medium outputs a second optical signal obtained by delaying the first optical signal by one cycle of the predetermined signal cycle. The optical multiplexing portion is connected to an output side of the first optical transmitting medium and the second optical transmitting medium and generates a third optical signal obtained by multiplexing the first optical signal and the second optical signal.

### BRIEF DESCRIPTION OF THE DRAWINGS

Exemplary embodiments of the invention will be described in detail based on the following figures, wherein:

FIG. 1 is a schematic diagram showing an example of a structure of a transmitting/receiving device according to a first exemplary embodiment of the invention;

FIG. 2 is an explanatory diagram showing a comparison between lengths of second and third optical fibers of a transmitting device according to the first exemplary embodiment of the invention;

FIGS. 3A to 3D are graphs showing an example of an operation of the transmitting device according to the first exemplary embodiment of the invention, FIG. 3A illustrating temporal changes in an input signal, FIG. 3B illustrating temporal changes in a first optical signal, FIG. 3C illustrating temporal changes in a second optical signal, and FIG. 3D illustrating temporal changes in a transmitting signal;

FIG. 4 is a circuit diagram showing an example of a circuit structure of a decoding portion according to the first exemplary embodiment of the invention;

FIG. 5 is a table showing a relationship between an input signal and a decoding signal in the decoding portion according to the first exemplary embodiment of the invention,

FIG. 6 is a schematic diagram showing an example of a structure of a transmitting/receiving device according to a second exemplary embodiment of the invention; and

FIG. 7 is a schematic diagram showing an example of a structure of a transmitting/receiving device according to a third exemplary embodiment of the invention.

### DETAILED DESCRIPTION

### First Exemplary Embodiment

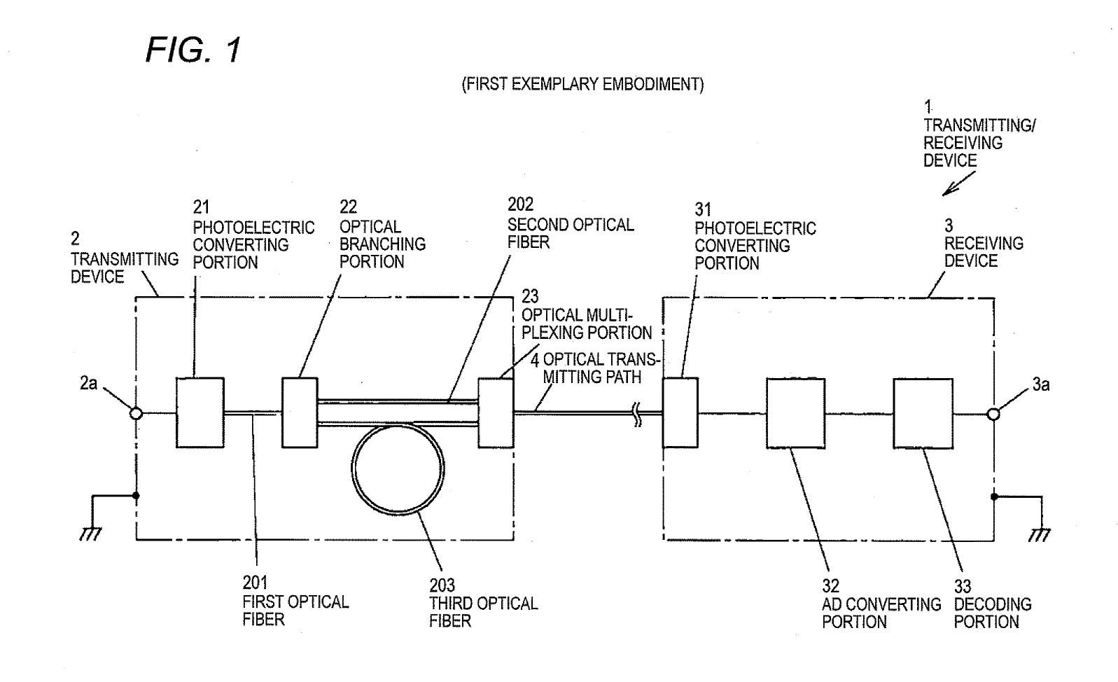

FIG. 1 is a schematic diagram showing an example of a structure of a transmitting/receiving device according to a first exemplary embodiment of the invention.

A transmitting/receiving device 1 includes a transmitting device 2, a receiving device 3, and an optical transmitting path 4 for connecting the transmitting device 2 and the receiving device 3 to each other.

### (Transmitting Device)

The transmitting device 2 includes a photoelectric converting portion 21, an optical branching portion 22, an optical multiplexing portion 23, and first to third optical fibers 201 to 203.

An input terminal 2a is connected to the photoelectric converting portion 21. An electric signal having a binary value of (0, 1) in a predetermined signal cycle is input to the input terminal 2a. The photoelectric converting portion 21 similarly converts the electric signal input to the input terminal 2a into an optical signal having a binary value of (0, 1) and inputs the optical signal to the first optical fiber 201.

In more detail, the photoelectric converting portion 21 causes a light source such as a light-emitting diode to emit a light and inputs a light having a predetermined intensity through the light emission to the first optical fiber 201 when the electric signal input to the input terminal 2a (the electric signal will be hereinafter referred to as an “input signal”) is High(1). Moreover, the photoelectric converting portion 21 does not cause the light source to emit a light and does not input the light to the first optical fiber 201 when the input electric signal is Low(0).

For the light source, it is also possible to apply a resonant-cavity light-emitting diode (RC-LED) or a semiconductor laser. In order to solve a problem of a light emission delay in switching of the signal from the Low to the High, moreover, it is also possible to emit a light on a sufficiently lower level in the case in which the input signal is the Low(0) as compared with the case of the High(1).

The first optical fiber 201 outputs, to the optical branching portion 22, the optical signal input from the photoelectric converting portion 21.

The optical branching portion 22 is constituted by an optical branching coupler formed by fuse welding, melting and elongating two optical fibers, for example. The optical branching portion 22 branches the optical signal output from the first optical fiber 201 and inputs the optical signal thus branched to the second optical fiber 202 and the third optical fiber 203. The second optical fiber 202 is illustrative as a first optical transmitting medium according to the invention and the third optical fiber 203 is illustrative as a second optical transmitting medium according to the invention.

As the first to third optical fibers 201 to 203, it is possible to use Si based POF (Plastic Optical Fiber) having a core diameter of φ 0.48 mm, for example. As the first and second optical transmitting media, moreover, it is also possible to use a quartz fiber (HPCF Hard Plastic Clad Fiber) having a core diameter of φ 0.2 mm.

The second optical fiber 202 and the third optical fiber 203 send the input light to the optical multiplexing portion 23.

The optical multiplexing portion 23 multiplexes the first optical signal output from the second optical fiber 202 and the second optical signal output from the third optical fiber 203 and generates a third optical signal having an intensity obtained by adding intensities of both of the optical signals. The optical multiplexing portion 23 may be implemented by using the optical branching coupler formed by fuse welding, melting and elongating two optical fibers in opposite directions to each other, for example. Moreover, the optical multiplexing portion 23 outputs the third optical signal thus generated to the optical transmitting path 4. The optical signal output from the optical multiplexing portion 23 will be hereinafter referred to as a “transmitting signal”.

The second optical fiber 202 and the third optical fiber 203 have different lengths from input ends on the optical branching portion 22 side to output ends on the optical multiplexing portion 23 side, and the third optical fiber 203 is formed to have a greater optical length than the second optical fiber 202.

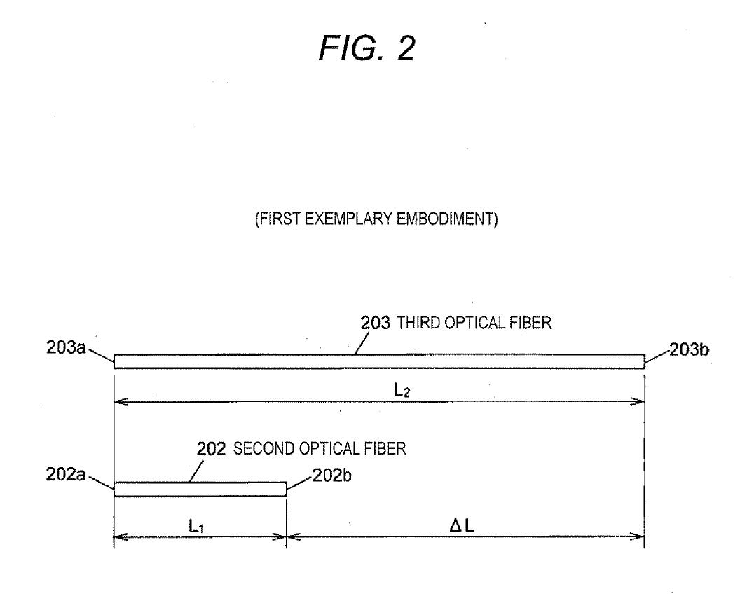

FIG. 2 is an explanatory diagram typically showing a state in which the second optical fiber 202 and the third optical fiber 203 are arranged in parallel with each other.

As shown in FIG. 2, the third optical fiber 203 has a distance L₂ from an incidence plane 203a at one of ends on the optical branching portion 22 side to an outgoing plane 203b at the other end on the optical multiplexing portion 23 side, and the second optical fiber 202 has a distance L₁ from an incidence plane 202a at one of the ends on the optical branching portion 22 side to an outgoing plane 202b at the other end on the optical multiplexing portion 23 side. L₂ is longer than L₁ and a difference between the lengths L₁ and L₂ is represented by ΔL.

The length of ΔL is equivalent to a distance at which a light travels along the second optical fiber 202 and the third optical fiber 203 in a time corresponding to a single cycle of an input signal. In other words, the optical signal output from the third optical fiber 203 to the optical multiplexing portion 23 is delayed by a single cycle from the optical signal output from the second optical fiber 202 to the optical multiplexing portion 23.

ΔL to be a difference in an optical length is equivalent to c₀/n/f, wherein a refractive index of a core in each of the second optical fiber 202 and the third optical fiber 203 is represented by n, a speed of a light in a vacuum is represented by c₀(m/s), and a frequency corresponding to a single cycle of an input signal is represented by f(Hz). For example, ΔL=0.2 m is obtained in accordance with the equation, wherein a refractive index of each of the second optical fiber 202 and the third optical fiber 203 is set to be 1.5, a transmitting speed of an input signal is set to be 1 Gbps (a frequency is set to be 1 GHz), and c₀=3×10⁸ (m/s) is set.

### (Operation of Transmitting Device)

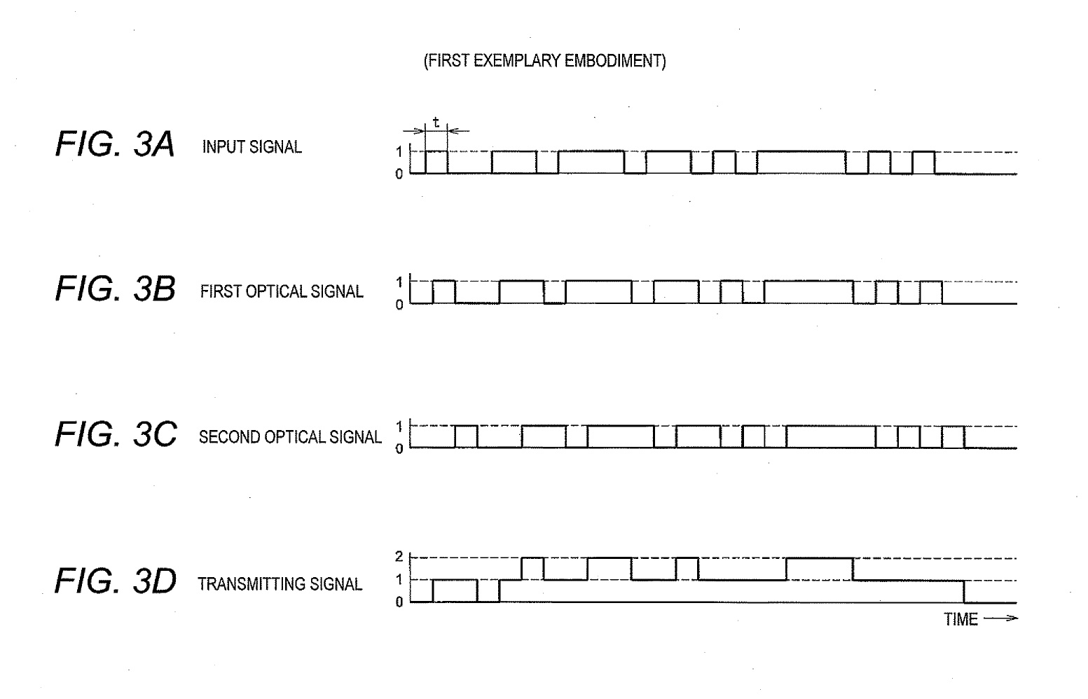

FIGS. 3A to 3D are graphs showing an example of temporal changes in the input signal, the optical output signals of the second optical fiber 202 and the third optical fiber 203, and the transmitting signal, and FIG. 3A shows a change in the input signal, FIG. 3B shows a change in the first optical signal output from the second optical fiber 202, FIG. 3C shows a change in the second optical signal output from the third optical fiber 203, and FIG. 3D shows a change in the transmitting signal output from the optical multiplexing portion 23.

The input signal takes a value of 0 or 1 in a predetermined signal cycle t (for example, 1 ns) as shown in FIG. 3A. The change in the input signal appears in the output (the first optical signal) of the second optical fiber 202 with a delay based on a response time of the photoelectric converting portion 21 or a time in which the optical signal is propagated along the first optical fiber 201 and the second optical fiber 202. Moreover, the change in the signal further appears in the output (the second optical signal) of the third optical fiber 203 with a delay corresponding to a single cycle depending on the length of ΔL from the output of the second optical fiber 202.

As shown in FIG. 3C, the transmitting signal is an optical signal having an intensity obtained by adding the intensity of the optical signal of the second optical fiber 202 and that of the optical signal of the third optical fiber 203. For example, if the intensities of the second optical fiber 202 and the third optical fiber 203 are set to be one when the input signal is one, the transmitting signal has a light intensity of two when both of the intensities of the optical signals in the second optical fiber 202 and the third optical fiber 203 are one. When the optical signal of the second optical fiber 202 or the third optical fiber 203 has an intensity of one, the transmitting signal has a light intensity of one. When both of the optical signals of the second optical fiber 202 and the third optical fiber 203 have an intensity of zero, the transmitting signal has a light intensity of zero.

Thus, the transmitting device 2 transmits a duo-binary signal obtained by converting an electric signal having a binary value of (0, 1) into an optical signal having a ternary value of (0, 1, 2) to the receiving device 3 through the optical transmitting path 4.

### (Optical Transmitting Path)

The optical transmitting path 4 is illustrative as a third optical transmitting medium according to the invention, and may be constituted by a single optical fiber or may be constituted by mutually coupling a plurality of optical fibers through an optical fiber coupler. Moreover, a relay amplifier may be provided between the optical fibers.

### (Receiving Device)

The receiving device 3 includes a photoelectric converting portion 31, an AD converting portion 32 and a decoding portion 33 as shown in FIG. 1. An output terminal 3a is connected to the decoding portion 33.

The photoelectric converting portion 31 converts the optical signal output from the optical transmitting path 4 into an electric signal, and amplifies and outputs the electric signal. The electric signal output from the photoelectric converting portion 31 has a signal level with a ternary value of (0, 1, 2) corresponding to the intensity of the optical signal transmitted through the optical transmitting path 4.

The AD converting portion 32 carries out an analog-digital conversion over the electric signal output from the photoelectric converting portion 31 and outputs a 2-bit signal. In other words, the AD converting portion 32 outputs a 2-bit signal having a high-order bit of one and a low-order bit of zero when the photoelectric converting portion 31 outputs a signal (2) having a high level. The AD converting portion 32 outputs a 2-bit signal having a high-order bit of zero and a low-order bit of one when the photoelectric converting portion 31 outputs a signal (1) having an intermediate level. Moreover, the AD converting portion 32 outputs a 2-bit signal having a high-order bit of zero and a low-order bit of zero when the photoelectric converting portion 31 outputs a signal (0) having a low level. The AD converting portion 32 outputs the 2-bit signal to the decoding portion 33.

The decoding portion 33 decodes a signal input to the input terminal 2a of the transmitting device 2 based on the 2-bit signal input from the AD converting portion 32 and outputs the decoded signal from the output terminal 3a.

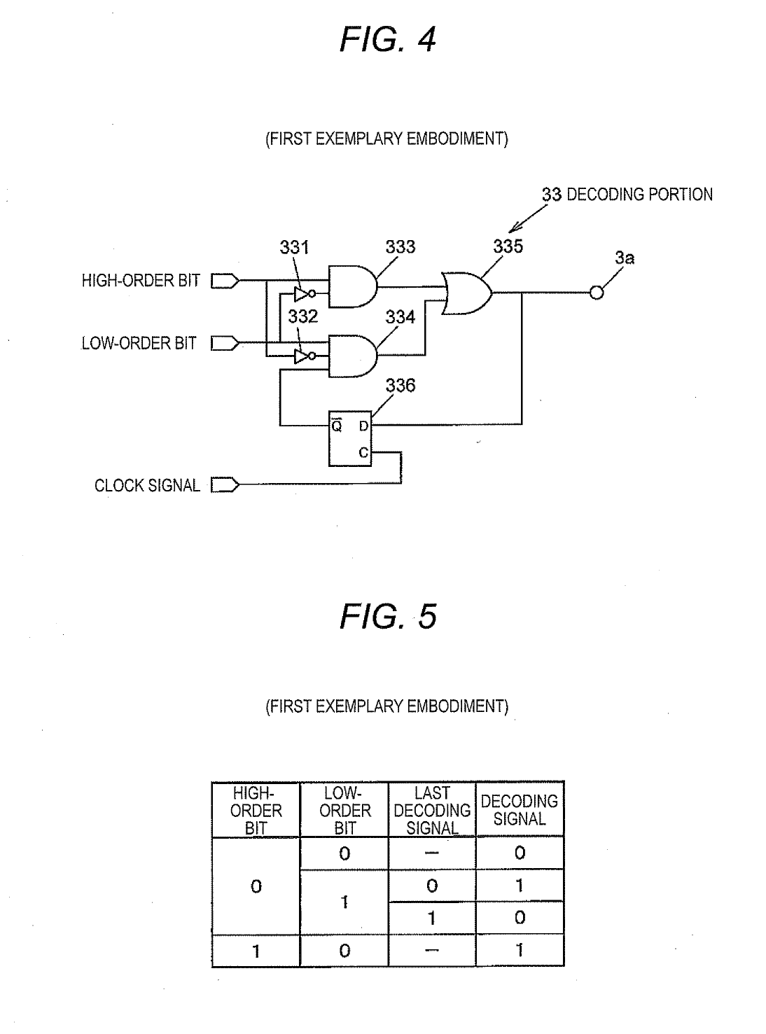

FIG. 4 is a circuit diagram showing an example of a circuit structure of the decoding portion 33. In the example, the decoding portion 33 has a first AND circuit 333 for inputting a signal obtained by inverting a low-order bit signal through an inverter 331 and a high-order bit signal, a second AND circuit 334 for inputting a signal obtained by inverting the high-order bit signal through an inverter 332, the low-order bit signal and a Q̅ signal of a D flip-flop circuit 336, and an OR circuit 335 for inputting an output of the first AND circuit 333 and that of the second AND circuit 334.

An output of the OR circuit 335 is sent from the output terminal 3a to an outside and is input to a D input terminal of the D flip-flop circuit 336. Moreover, a clock signal having an identical cycle to a signal cycle of the signal input to the transmitting device 2 is sent from a clock signal generating circuit (not shown) to a clock input terminal of the D flip-flop circuit 336. Consequently, the Q̅ signal of the D flip-flop circuit 336 is indicated as a signal obtained by inverting a signal with a one-cycle delay from a signal output from the output terminal 3a (which will be hereinafter referred to as a “decoding signal”), that is, a last decoding signal.

FIG. 5 is a table showing a relationship between the high-order and low-order bit signals input to the decoding portion 33 having the structure described above and the decoding signal to be the output of the decoding portion 33. As shown in the table, the decoding signal is zero irrespective of the last decoding signal if both of the high-order and low-order bit signals are zero, and the decoding signal is one irrespective of the last decoding signal if the high-order bit signal is one and the low-order bit signal is zero. When the high-order bit signal is zero and the low-order bit signal is one, furthermore, the decoding signal is one if the last decoding signal is zero and the decoding signal is zero if the last decoding signal is one.

The decoding portion 33 thus executes the decode processing so that a decoding signal reproducing the signal input to the transmitting device 2 is sent from the output terminal 3a.

According to the transmitting/receiving device 1 having the structure described above, it is possible to generate a duo-binary signal based on the difference in the optical length between the second optical fiber 202 and the third optical fiber 203. For example, it is possible to carry out a transmission permitting an intersymbolic interference which might occur in an execution of a long-distance transmission.

### Second Exemplary Embodiment

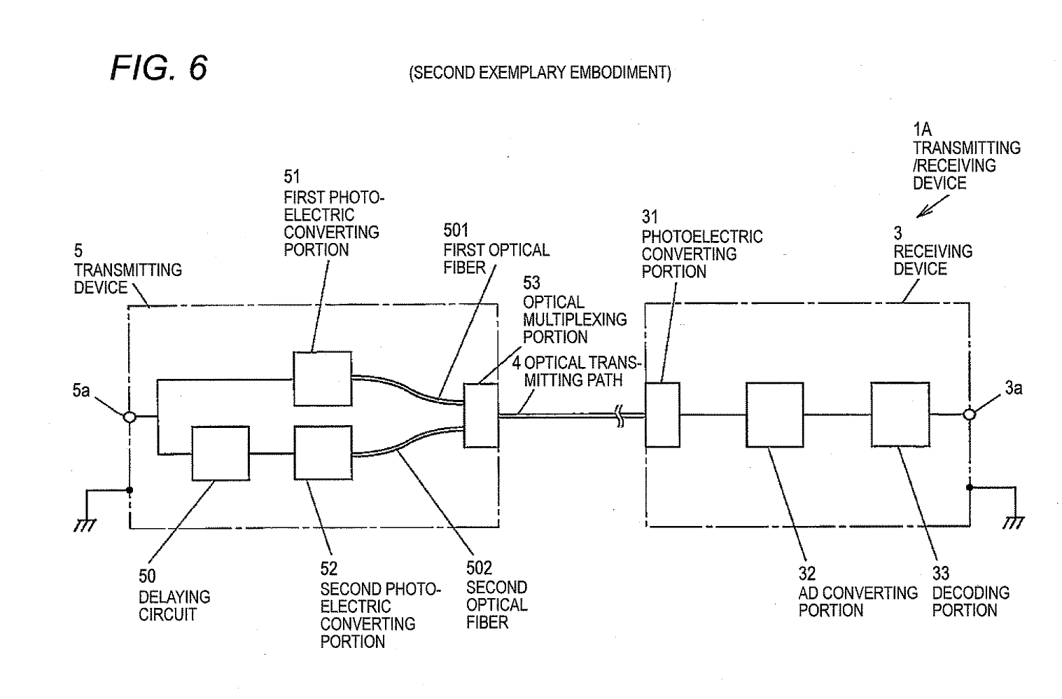

Next, a second exemplary embodiment according to the invention will be described with reference to FIG. 6.

FIG. 6 is a schematic diagram showing an example of a structure of a transmitting/receiving device according to the exemplary embodiment. Although a transmitting/receiving device 1A includes a transmitting device 5, a receiving device 3 and an optical transmitting path 4, structures of the receiving device 3 and the optical transmitting path 4 are the same as those described in the first exemplary embodiment. Therefore, they have the same reference numerals and description thereof will be omitted.

The transmitting device 5 according to the exemplary embodiment includes an input terminal 5a, a first photoelectric converting portion 51 which is directly connected to the input terminal 5a, a second photoelectric converting portion 52 connected to the input terminal 5a through a delaying circuit 50, and an optical multiplexing portion 53 connected to a first optical fiber 501 connected to the first photoelectric converting portion 51 and a second optical fiber 502 connected to the second photoelectric converting portion 52. The first optical fiber 501 is illustrative as a first optical transmitting medium according to the invention. The second optical fiber 502 is illustrative as a second optical transmitting medium according to the invention.

The first photoelectric converting portion 51 accepts a signal input to the input terminal 5a without a delaying circuit, and outputs a light having a predetermined intensity to the first optical fiber 501 if the input signal is High(1). If the input signal is Low(0), moreover, the first photoelectric converting portion 51 does not cause a light source to emit a light and does not output the light to the first optical fiber 501.

The delaying circuit 50 serves to generate a delay corresponding to a single signal cycle of an electric signal input to the input terminal 5a. The delaying circuit 50 may be implemented by a flip-flop circuit which is synchronized with a cyclic signal (CLK), for example.

The second photoelectric converting portion 52 accepts the input signal delayed by the delaying circuit 50, and causes a light source such as a light-emitting diode to emit light and inputs, to the second optical fiber 502, a light having a predetermined intensity through the light emission if the signal is High(1). If the signal is Low(0), moreover, the second photoelectric converting portion 52 does not cause the light source to emit a light and does not input the light to the second optical fiber 502.

The first optical fiber 501 outputs, to the optical multiplexing portion 53, an optical signal input from the first photoelectric converting portion 51. Moreover, the second optical fiber 502 outputs, to the optical multiplexing portion 53, an optical signal input from the second photoelectric converting portion 52. It is assumed that the first optical fiber 501 and the second optical fiber 502 have optical lengths which are equal to each other.

The optical multiplexing portion 53 multiplexes a first optical signal input from the first optical fiber 501 and a second optical signal input from the second optical fiber 502, and generates a third optical signal obtained by adding intensities of the first and second optical signals. Furthermore, the optical multiplexing portion 53 outputs, to the optical transmitting path 4, the third optical signal thus generated as a transmitting signal.

The transmitting device 5 outputs the same transmitting signal as that in the transmitting device 1 described in the first exemplary embodiment. In other words, when the input signal shown in FIG. 3A is input to the input terminal 5a, for example, the first optical signal having the waveform shown in FIG. 3B is output from the first optical fiber 501 and the second optical signal having the waveform shown in FIG. 3C is output from the second optical fiber 502. The third optical signal (the transmitting signal) having the waveform shown in FIG. 3D is output from the optical multiplexing portion 53.

### Third Exemplary Embodiment

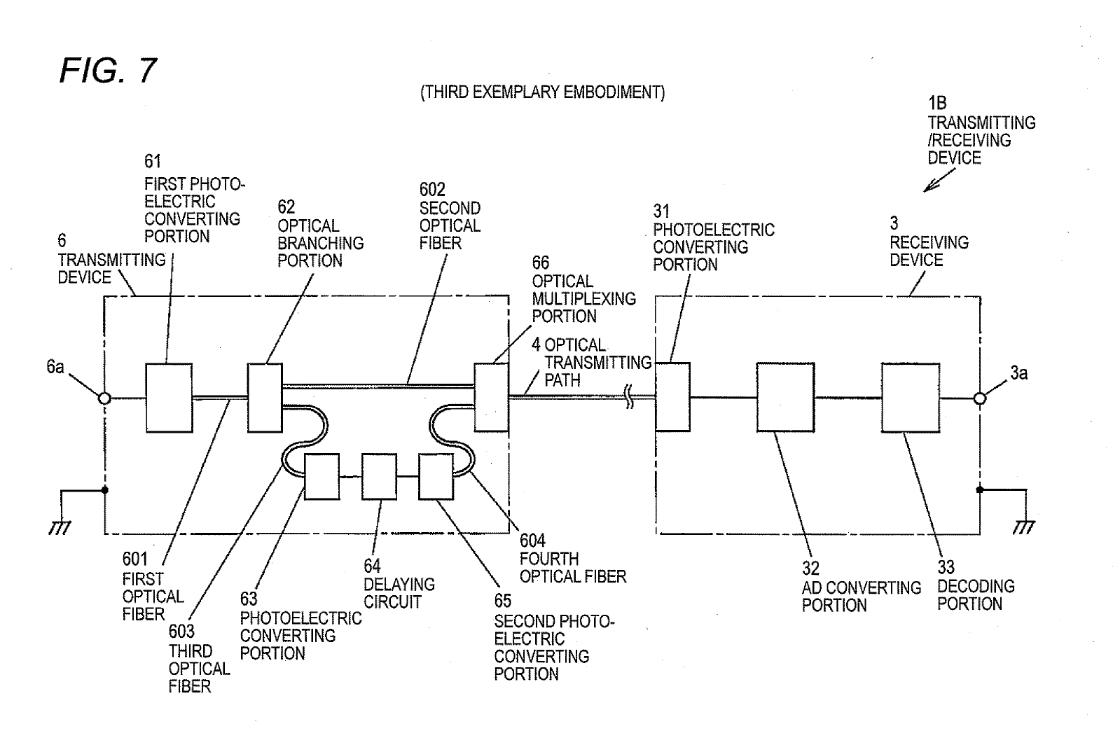

Next, a third exemplary embodiment according to the invention will be described with reference to FIG. 7.

FIG. 7 is a schematic diagram showing an example of a structure of a transmitting/receiving device according to the exemplary embodiment. Although a transmitting/receiving device 1B includes a transmitting device 6, a receiving device 3 and an optical transmitting path 4, structures of the receiving device 3 and the optical transmitting path 4 are the same as those described in the first exemplary embodiment. Therefore, they have the same reference numerals and description thereof will be omitted.

The transmitting device 6 according to the exemplary embodiment includes an input terminal 6a, a first photoelectric converting portion 61 connected to the input terminal 6a, an optical branching portion 62 connected to the first photoelectric converting portion 61 through a first optical fiber 601, a photoelectric converting portion 63 connected to the optical branching portion 62 through a third optical fiber 603, a delaying circuit 64 connected to the photoelectric converting portion 63, a second photoelectric converting portion 65 connected to the delaying circuit 64, and an optical multiplexing portion 66 connected to the optical branching portion 62 through a second optical fiber 602 and connected to the second photoelectric converting portion 65 through a fourth optical fiber 604 respectively.

The second optical fiber 602 is illustrative as a first optical transmitting medium according to the invention. The fourth optical fiber 604 is illustrative as a second optical transmitting medium according to the invention.

The first photoelectric converting portion 61 accepts a signal input to the input terminal 6a, and outputs a light having a predetermined intensity to the first optical fiber 601 if the input signal is High(1). If the input signal is Low(0), moreover, the first photoelectric converting portion 61 does not cause a light source to emit a light and does not output the light to the first optical fiber 601. The first optical fiber 601 outputs, to the optical branching portion 62, the optical signal input from the first photoelectric converting portion 61.

The optical branching portion 62 branches the optical signal output from the first optical fiber 601 into the second optical fiber 602 and the third optical fiber 603 and outputs the branched optical signals. The optical signal input to the second optical fiber 602 is directly output to the optical multiplexing portion 66. The optical signal input to the third optical fiber 603 is output to the photoelectric converting portion 63.

The photoelectric converting portion 63 converts the optical signal output from the third optical fiber 603 into an electric signal, and outputs the electric signal to the delaying circuit 64. An output of the delaying circuit 64 is input to the second photoelectric converting portion 65. The second photoelectric converting portion 65 outputs the input electric signal to the optical multiplexing portion 66 through the fourth optical fiber 604.

A delay time of the delaying circuit 64 is set in such a manner that a delay corresponding to a single signal cycle of the input signal is generated in the second optical signal output from the fourth optical fiber 604 with respect to the first optical signal output from the second optical fiber 602. By setting a sum of optical lengths of the third optical fiber 603 and the fourth optical fiber 604 to be equal to an optical length of the second optical fiber 602, it is possible to set the delay time of the delaying circuit 64 corresponding to the signal cycle of the input signal.

The optical multiplexing portion 66 multiplexes the first optical signal input from the second optical fiber 602 and the second optical signal input from the fourth optical fiber 604 and generates a third optical signal obtained by adding intensities of the first and second optical signals. Moreover, the optical multiplexing portion 66 outputs, to the optical transmitting path 4, the third optical signal generated as a transmitting signal.

The transmitting device 6 outputs the same transmitting signal as that of the transmitting device 1 described in the first exemplary embodiment. In other words, in the case in which the input signal shown in FIG. 3A is sent to the input terminal 6a, for example, the first optical signal having the waveform shown in FIG. 3B is output from the second optical fiber 602 and the second optical signal having the waveform shown in FIG. 3C is output from the fourth optical fiber 604. The third optical signal (the transmitting signal) having the waveform shown in FIG. 3D is output from the optical multiplexing portion 66.

### Other Exemplary Embodiment

The invention is not restricted to each of the exemplary embodiments but various changes may be made without departing from the scope of the invention.

Although optical fibers having equal refractive indices are used for the second optical fiber 202 and the third optical fiber 203 to generate the delay of the optical signal depending on the difference between the lengths in the first exemplary embodiment, for example, the invention is not restricted thereto but a difference in an optical length (which is equal to a multiplication of an actual distance by a refractive index: an optical distance) may be made based on a difference in the refractive index between the second optical fiber 202 and the third optical fiber 203 or a difference in the refractive index and the length and the delay of the optical signal may be generated based on the difference.

Although the delay of the signal is generated by the delaying circuit 50 in the second exemplary embodiment, moreover, a delay of an optical signal corresponding to a single cycle may be generated by a combination of a delay made by the delaying circuit 50 and a delay based on the optical lengths of the first optical fiber 501 and the second optical fiber 502.

Although the delaying circuit 64 is provided in one of the two paths reaching the optical multiplexing portion 66 from the optical branching portion 62 in the third exemplary embodiment, furthermore, the invention is not restricted thereto but delaying circuits may be provided in both of the paths to generate a delay of an optical signal corresponding to a single cycle depending on a difference between delay times thereof.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

### EXPLANATION OF DESIGNATION

1, 1A, 1B transmitting/receiving device
2 transmitting device
2a input terminal
3 receiving device
3a output terminal
4 optical transmitting path
5 transmitting device
5a input terminal
6 transmitting device
6a input terminal
21 photoelectric converting portion
22 optical branching portion
23 optical multiplexing portion
31 photoelectric converting portion
32 AD converting portion
33 decoding portion
50 delaying circuit
51 first photoelectric converting portion
52 second photoelectric converting portion
53 optical multiplexing portion
61 first photoelectric converting portion
62 optical branching portion
63 photoelectric converting portion
64 delaying circuit
65 second photoelectric converting portion
66 optical multiplexing portion
201 first optical fiber
202 second optical fiber
203 third optical fiber
202a, 203a incidence plane
202b, 203b outgoing plane
331, 332 inverter
333, 334, 335 OR circuit
336 flip-flop circuit
501 first optical fiber
502 second optical fiber
601 first optical fiber
602 second optical fiber
603 third optical fiber
604 fourth optical fiber

What is claimed is:

1. A transmitting device comprising:
a first optical transmitting medium that outputs a first optical signal having a predetermined signal cycle;
a second optical transmitting medium that outputs a second optical signal obtained by delaying the first optical signal by one cycle of the predetermined signal cycle; and
an optical multiplexing portion that is connected to an output side of the first optical transmitting medium and an output side of the second optical transmitting medium and generates a third optical signal obtained by multiplexing the first optical signal and the second optical signal.

2. The transmitting device according to claim 1 further comprising an optical branching portion that branches an input optical signal and outputs the branched optical signal to the first optical transmitting medium and the second optical transmitting medium,
wherein a length from one end of the second optical transmitting medium connected to the optical branching portion to the other end of the second optical transmitting medium connected to the optical multiplexing portion is a second length,
a length from one end of the first optical transmitting medium connected to the optical branching portion to the other end of the first optical transmitting medium connected to the optical multiplexing portion is a first length which is shorter than the second length, and
a difference between the first length and the second length is substantially equal to a distance at which a light travels in the second optical transmitting medium for one cycle of the predetermined signal cycle.

3. A transmitting/receiving device comprising:
the transmitting device according to claim 1;
a receiving device that receives and decodes the third optical signal generated in the optical multiplexing portion; and
a third optical transmitting medium that connects the transmitting device to the receiving device.

4. A transmitting/receiving device comprising:
the transmitting device according to claim 2;
a receiving device that receives and decodes the third optical signal generated in the optical multiplexing portion; and
a third optical transmitting medium that connects the transmitting device to the receiving device.
